(19) United States
(12) Patent Application Publication
(10) Pub. No.: US 2007/0041357 A1
(43) Pub. Date: Feb. 22, 2007

(54) Interworking of hybrid protocol multimedia networks

(76) Inventors: Klaus Hoffmann, Munich (DE); Sven Sabrowski, Munich (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/571,501

(22) PCT Filed: Sep. 3, 2004
(86) PCT No.: PCT/EP04/52031

§ 371 Date: Mar. 10, 2006

(30) Foreign Application Priority Data
Sep. 12, 2003 (DE) 103 42 294.3

(51) Int. Cl. H04L 12/66

(52) U.S. Cl. 370/352

(57) ABSTRACT

According to the invention, on carrying out the configuration of connections in a hybrid network, comprising PSTN and IN networks, messages generated in the PSTN network are transformed into IN network messages before a decentralised interruption of the connections in the IN network occurs by deactivation of the unidirectional transmitter at the end of the connections and before the type of the configuration makes activation of the transmitter in the IN network necessary. The performance features 3PTY and CONF of the PSTN network can advantageously also be provided for interworking with IN networks, such that no useful information is transmitted in the IN networks so long as a connection in a conference is isolated.

### CROSS REFERENCE TO RELATED APPLICATIONS

This application is the US National Stage of International Application No. PCT/EP2004/052031, filed Sep. 3, 2004 and claims the benefit thereof. The International Application claims the benefits of German application No. 10342294.3 DE filed Sep. 12, 2003, both of the applications are incorporated by reference herein in their entirety.

### FIELD OF INVENTION

This present invention relates to interworking of hybrid protocol multimedia networks.

### BACKGROUND OF INVENTION

In the past two important types of communication networks have been developed for transmitting information: Packet-oriented (data) networks and circuit-oriented (speech) networks. During the convergence of these two types of network, convergent multimedia networks have been developed. The merging of these different network types has given rise to hybrid networks.

Circuit-oriented networks—also known as speech networks, telephone networks or public switched telephone networks (PSTN)—are designed for the transmission of continuous streams of information also known among experts as speech connections, voice communications or calls. The information is usually transmitted with high service quality and security. For example a minimal delay—usually under 200 ms—with no fluctuation in the delay time (delay jitter) is important for speech, since when reproduced in the receiving device speech requires a continuous flow of information. It is therefore not possible to compensate for information loss by repeatedly transmitting the missing information, since it usually leads to audible interference in the receiving device (e.g. crackling, distortion, echo, silence). Among professionals, speech transmission is also known by the general term realtime transmission service.

Packet-oriented networks—also known as data networks—are designed for transmitting packet streams, also known among experts as data packet streams, sessions or flows. In this case a high service quality does not usually need to be guaranteed. In the absence of guaranteed service quality, packet streams may be transmitted with fluctuating delay times, since the individual data packets in data packet streams are usually transmitted in the order in which they accessed the network, that is, the more packets that have to be transmitted by a data network, the greater the delay times. Among professionals, data transmission is also known as a non-realtime service.

Packets are usually differentiated according to the type of packet-oriented network. For instance they can be formed as Internet, X.25, or frame relay packets, or as ATM cells. They are also sometimes known as messages, such as when a message is transmitted within a packet.

A known data network is the Internet. Due to the IP protocol which is used in the Internet, it is sometimes also called the IP network, though this term is in fact applied widely and includes all networks in which the IP protocol is used. The Internet is designed as an open (long distance) data network with open interfaces for connecting (mostly local and regional) data networks provided by different manufacturers. It constitutes a manufacturer-independent transport platform.

Connections are communication relationships between at least two subscribers for the purpose of the mostly bidirectional transmission of information. The subscriber initiating the connection is usually known as the ‘A subscriber’. A subscriber connected to an A subscriber is called the ‘B subscriber’. In a wireless network, connections represent at least the relationship between the A and B subscribers, which is unequivocal at the logically abstract level. Thus according to this point of view the wireless flows in the Internet represent logically abstracted connections (for example the A subscriber=browser and the B subscriber=web Server). In a connection-oriented network, connections also represent at the physical level unequivocal paths through the network, along which information is transmitted.

Signaling is used for matching network components together, but not for the “actual” transmission of information in the above sense. The information transmitted for the purpose of signaling is usually known as signaling information, signaling data or simply signaling. The term is applied widely. For example it also includes the messages for controlling registration, admission and status (RAS), the messages for controlling the data channels of established calls (e.g. according to the H.245 standard) and all further similarly formed messages. To distinguish the “actual information” from the signaling it is also called useful information, payload, media information, media data or simply media. Communication relationships used for the transmission of signaling are also referred to below as signaling connections. The communication relationships used for transmitting useful information may be called speech connections, data channel connections or simply data channel, bearer channel or just bearer.

In this context the expression out-of-band or outband refers to the transmission of information over a path or medium which is not the same as that provided in the communication network for transmitting signaling and useful information. In particular this involves configuring devices locally, and is typically carried out with the aid of a local control device. In contrast, the expression inband refers to transmitting information over the same path or medium, if necessary logically separated from the signaling and useful information concerned.

During the convergence of speech and data networks, speech transmission services and increasingly also broadband services such as transmission of video information are also being produced in packet-oriented networks, that is, transmission of realtime services that until now were usually transmitted by circuit-oriented means now takes place in a convergent network —also known as a speech-data network or multimedia network—by packet-oriented means, that is, in packet streams. These are also called realtime packet streams. The transmission of speech information over a packet-oriented IP network is also called ‘VoIP’ (voice over IP).

The international standardization committees known as the IETF (Internet Engineering Task Force) and the ITU (International Telecommunications Union) describe a plurality of distributed architectures for multimedia networks, initially based on homogeneous multimedia networks.

In the case of the ITU the transport of speech, data and video streams via an IP network is defined in the relevant, fundamental standard H.323. In this, audio and video streams are transmitted according to the RTP/RTCP protocol. Connection control is performed by among other things the H.225 protocol, which enables signaling, registration and the synchronization of media streams. The H.323 architecture mainly provides the following types of function units:
Terminal, typically in a local area network (LAN), for bidirectional realtime communication with other terminals,
Gatekeeper for performing connection control,
Media gateway (MG) on the interface to other networks, for converting from H.323 formats to the formats of said other networks,
Media gateway controller (MGC) for controlling media gateways, in particular their transferred connections, with the aid of protocol H.248, and for converting between different signaling protocols.

In the case of the IETF, telephony via the Internet is standardized in the form of session initiation protocol (SIP), which can establish interactive connections via the Internet. SIP supports connection control and the translation of SIP addresses into IP addresses. SIP is based on comparatively intelligent end points, many of which perform the actual signaling function. When a connection is established with the aid of SIP, a description of the bearer is usually exchanged between the two sides of the connection. The session description protocol (SDP) according to standard RFC2327 is used for this purpose. This approach is described in among other things standard RFC3264: “An Offer/Answer Model with the Session Description Protocol (SDP)”. The following bearer data is extremely important in this connection:
IP address of the bearer connection
RTP/UDP port of the bearer connection (depending whether speech or data transmission is involved)
Codec(s) which are (or may be) used for speech or data transmission
Stream mode of the bearer connection.

A SIP proxy server can be used in the case of a connection setup, for example if the end points of the connection are not known. It can also be designed to analyze, change and/or forward an incoming request for a client (such as an IP telephone, a PC or a PDA). MGs and MGCs are likewise provided on the interface to other networks. MGCP (media gateway control protocol) is used to control the MGs.

A common feature of both architectures is that the connection control level and the resource control level are clearly separated from one another functionally and in most cases are even embodied on different hardware platforms.

The connection control level provides controlled activation and deactivation of network services. For this purpose it can have dedicated connection controllers to which the following functions can be assigned:
Address translation: Converting E. 164 telephone numbers and other alias addresses (e.g. computer names) into transport addresses (e.g. Internet addresses).
Admission control: Checking whether and/or to what extent use of the communication network is permitted.
Alias address modification: Returning a modified alias address to be used by end points for such matters as the connection establishment procedure.
Bandwidth control: Managing transmission capacities, for example by controlling the permitted number of devices that can use the communication network simultaneously.
Connection authorization: Checking the authorization for incoming and outgoing connection requests.
Connection control signaling: Handling and/or processing signaling messages.
Connection management: Managing existing connections.
Dialed digit translation: Converting dialed digits into an E. 164 telephone number or a number from a private numbering scheme.
Zone management: Registering devices (such as those that are VoIP-enabled) and providing the said functions for all devices registered with the connection controller.

The resource control level provides controlled performance of activated services. For the purpose of controlling network resources (such as transmission nodes) it can have dedicated resource controllers to which the following functions can be assigned:
Capacity control: Controlling the traffic volume supplied to the communication network, for instance by monitoring and if necessary limiting the permitted transmission capacity of individual packet streams.
Policy activation: Reserving resources (in particular transmission resources) in the communication network.
Priority management: Preferentially transmitting priority traffic streams, for instance with the aid of priority identifiers provided in priority packets.

The ITU H.323 gatekeeper or the SIP proxy are examples of connection controllers. If a large communication network is divided into a plurality of domains (also known as ‘zones’), a separate connection controller can be provided in each domain. A domain can also be operated without a connection controller. If a plurality of connection controllers is provided in a domain, only one of these shall be activated. From the logical point of view a connection controller is deemed to be separate from the various devices. Physically, however, a connection controller does not necessarily have to be a separate device, but can also be provided in any endpoint of a connection (for example in the form of a H.323 or SIP terminal, media gateway or multipoint control unit) or even in a primary device designed for program-controlled data processing (such as a computer, PC or server). A physically distributed approach is also possible.

An alternative example of a connection controller is a media gateway controller, to which are usually assigned the optional functions of connection control signaling and connection management. It is also possible to assign a signaling conversion function for translating different protocols (usually signaling protocols); this situation may occur at the boundary between two separate networks that are merged as a hybrid network.

The resource controller is also known as a ‘policy decision point (PDP)’. It typically forms part of a component called an edge router, which is also known as an edge device, an access node or, when assigned to an Internet service provider (ISP), a provider edge router (PER). Said edge routers can also take the form of a media gateway to other networks to which the multimedia networks are connected. These media gateways are then connected both to a multimedia network and to the other networks, and provide internal translation between the different transmission protocols in the different networks. The resource controller can also be designed as a proxy only, and resource controllers then forward relevant information to a separate device where said relevant information is processed in accordance with a function of the resource controller.

Signaling messages are exchanged in these networks either by being handled by a connection controller (connection controller routed signaling—CCRS) or by being exchanged directly between terminals (direct endpoint routed signaling—DERS). For each connection it is possible to define which variant is used for each terminal and for each transmission direction on an individual basis.

In the case of CCRS, all signaling messages are transmitted by at least one call controller. All devices send and receive signaling messages via the call controller only. In this situation the direct exchange of signaling messages between devices is prohibited.

In the case of DERS, copies of selected signaling messages can be transmitted to connection controllers so that a connection controller can be aware of the connections existing between terminals in this variant also. However, the said connection controller does not actively influence or verify these connections.

### SUMMARY OF INVENTION

In summary the function split between the two levels can be described in such a way that the only functions assigned to the resource control level are those that are required for transmitting useful information, whereas the intelligence for controlling the resource control level is covered by the connection control level. In other words: Devices at the resource control level have the least possible network control intelligence and consequently can be produced cost-effectively and to particular advantage on separate hardware platforms. Bearing in mind the higher number of installations at this level compared to the connection control level, this is a particularly great advantage.

The merging of different networks has brought about hybrid networks in which different protocols are used. In order that in a network of this type all devices can communicate with one another without restriction (such as IP-based telephones compatible with PSTN and vice-versa), interworking is necessary between the respective protocols (such as SIP and H.323 in packet-oriented multimedia networks or ISUP and DSS 1 in circuit-oriented PSTN networks). This interworking has to be taken a long way and includes not only pure interworking between bearers but also interworking between performance features or services such as Call Hold, Call Waiting, Call Redirect, 3PTY (three-party conferencing—also known as a ‘small conference’—see ITU-T standard Q.734.2) or CONF (a conference without restriction on the number of participants—also known as a ‘large conference’—see ITU-T standard Q.734.1).

Interworking between two different protocols can take place directly or indirectly. In the case of indirect interworking, a further, third protocol is interposed between the two protocols —for example the BICC protocol (bearer independent call control) according to standard Q.1902 or the SIP_T protocol (SIP for telephones), described in the RFC3372 standard. On the other hand, direct interworking takes place directly between the two different protocols, that is, without the use of an intermediate protocol.

Both in convergent multimedia networks and in hybrid networks, formed for example due to a merging of a convergent multimedia network with a conventional circuit-oriented speech network, new technical problems arise when information is being transmitted—in particular in realtime packet streams—due to the new or different technologies used in the respective network types.

An object of the invention is to identify at least one of these problems and to enlarge on the prior art by specifying at least one solution.

The invention is based on the finding that during the evolution of hybrid networks that arise from the merging of proven circuit-oriented networks with modem multimedia networks, many of the long-established performance features of circuit-oriented networks are either not fully supported or not supported at all. One reason for this can be seen in the large number of new interworking interfaces and protocols which do not yet support or do not fully support the former performance features.

The invention is further based on the finding that the differentiated specifications for bearer handling in PSTN networks and in SIP networks are not suited to one another. Whereas in PSTN networks the partner is notified that its own outgoing direction is blocked, in SIP networks the partner must be notified that it (from the viewpoint of the signaling party) must interrupt the remote outgoing direction, since in SIP networks only the home outgoing direction is disconnected, and not the home incoming direction. In other words: In SIP networks each SIP subscriber interrupts its own outgoing direction itself by deactivating its transmitter (see IETF standard RFC3264, chap. 8.4).

This discrepancy is further compounded in that in the IETF standard RFC3264 (offer/answer) for SIP, generally the bearer is required to be rerouted during holding conditions, which is intended to bring about a reduction in the required bandwidth in SIP networks. This requirement also extends to hybrid networks resulting from the merging of SIP networks and PSTN networks, even when in fact rerouting of the bearer in the SIP network would hardly be necessary at all in order to carry out a performance feature, because in the PSTN network all the necessary steps for successful execution of the performance feature have already been taken. For instance when establishing a conference in the PSTN network a connection to a SIP subscriber can be switched to hold without any problem, because in this case the associated switching center interrupts the connection between the two subscribers centrally in both transmission directions. In this case incoming information from the SIP subscriber is discarded in this switching center, which is by and large advantageous for the desired establishment of a conference. Even so, in ITU-T draft standard Q. 1912.SIP, interworking of the BICC/ISUP protocols on the SIP protocol standardized how the BICC/ISUP indications for “remote hold” and “remote retrieve” are to be mapped onto a SIP protocol.

The invention is based on the recognition that the indicators “remote hold” and “remote retrieve” are used not only during the execution of the HOLD performance feature, but also during the execution of the 3PTY and CONF performance features. As a result, due to the use of the “remote hold” indicators in addition to the central interruption of the connections in the PSTN network, the establishment of a conference is accompanied by a deactivation of the SIP-side transmitter.

In the interworking scenario of the said hybrid network this deactivation cannot be resolved, since in the relevant interworking draft standard Q.1912.SIP from the ITU-T this problem is not addressed and there are no instructions with regard to a solution.

A solution to this problem to which the invention relates is specified in the claims.

This solution is connected to a plurality of advantages:
On carrying out the configuration of connections according to the first protocol, messages generated in the circuit-oriented network are mapped onto messages of the second protocol in the multimedia network before a decentralized interruption of the connections occurs by deactivation of the unidirectional transmitter at the end of the connections and before the type of the configuration makes activation of the transmitter necessary. Thus a proposed method enables the operator to offer SIP the features 3PTY and CONF even in a hybrid ISUP/BICC/H323 network with interworking.
By parallel disconnection of data channels, initially according to the first protocol by central interruption in a central transmission node of the circuit-oriented network and then, during interworking in the second protocol, by deactivation of the transmitter in the multimedia network, an optimum load reduction is achieved in the hybrid network. The proven performance features 3PTY and CONF of circuit-oriented networks can advantageously also be provided for interworking with multimedia networks, such that no useful information is transmitted in the multimedia networks so long as a connection in a conference is isolated.

Further advantageous embodiments of the invention will emerge from the claims.

The specification of a detailed regulation for mapping Q.734 messages onto SIP messages brings with it the great advantage that further development of the Q.1912.SIP draft standard (version July 2003) is significantly simplified.

The status-dependent form of SIP messages as either INVITE or UPDATE advantageously satisfies the recommendation of the IETF standard RFC331 1, Chap. 5.1, according to which on the one hand a repeat transmission of an INVITE in the “before answer” state is not allowed, because this can lead to differentiation difficulties with the original INVITE, while on the other hand after the answer “200 OK” (also called “confirmed dialogue”) it would likewise be possible to send an UPDATE, but the repeat transmission of an INVITE (also called “re-INVITE”) is recommended.

### BRIEF DESCRIPTION OF THE DRAWINGS

The invention will be explained in greater detail below with the aid of further exemplary embodiments that are also shown in the drawings. These show the following:

FIG. 1 An exemplary arrangement for executing the inventive method with a hybrid communication network, consisting of two packet-oriented multimedia networks and one circuit-oriented speech network that are connected by interposed media gateways, media gateway controllers and SIP proxies, each also having one endpoint of a common performance feature in each of the three networks;

FIG. 2 A flowchart showing an exemplary embodiment of the invention.

### DETAILED DESCRIPTION OF INVENTION

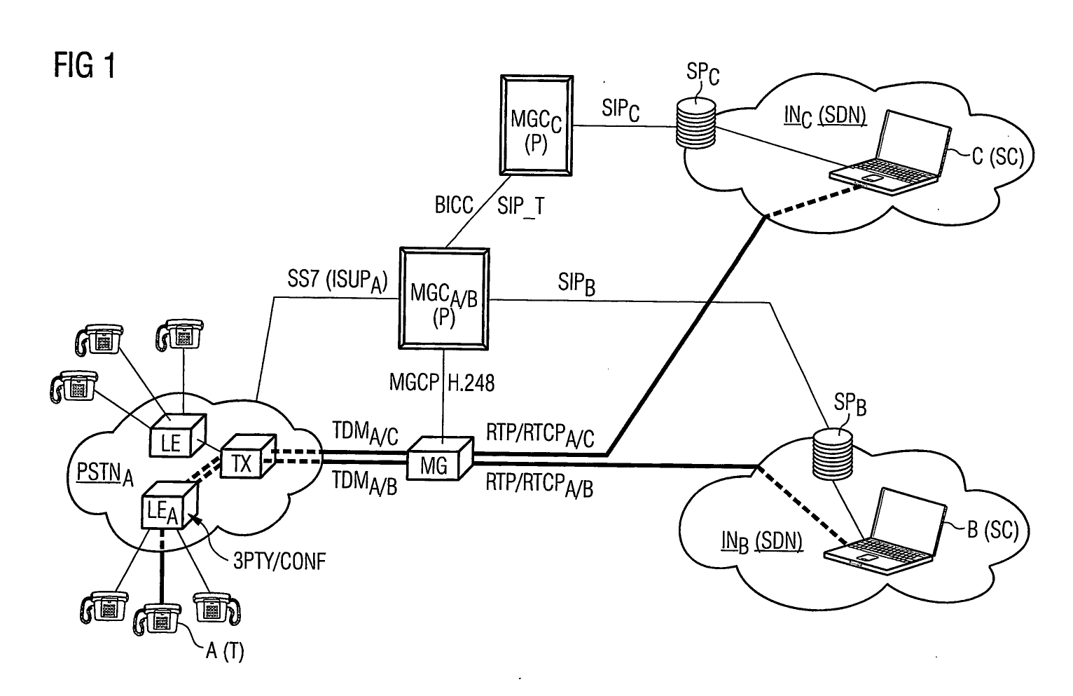

FIG. 1 shows an exemplary arrangement for executing the inventive method. It includes a circuit-oriented network PSTNA and two multimedia networks INB and INc, preferably in the form of integrated speech-data networks SDN. The networks PSTNA, INB and INC are merged as a hybrid network. The networks IN preferably take the form of IP networks and each includes a call controller being a SIP proxy SPB or SPC. From the viewpoint of the relevant prior art it is clear that the invention can obviously be used in any packet-oriented networks IN such as Internet, intranet, extranet, a local area network (LAN) or for example a corporate network in the form of a virtual private network (VPN).

A subscriber A is connected to the network PSTNA by means of a conventional telephone T, while subscribers B and C are connected to the networks IN_{B} and IN_{C} by means of SIP-enabled telephones such as software-based SIP clients SC. Between subscribers A and B there is a connection which includes an end-to-end data channel TDM_{A/B}, RTP/RTCP_{A/B} as bearer. Between subscribers A and C there is also a further connection which includes an end-to-end data channel TDM_{A/C}, RTP/RTCP_{A/C} as bearer. Assigned to the subscriber A is a circuit-oriented switching device LEA that includes a controller for performance features 3PTY or CONF by means of which the connections in the context of the performance features can be configured and in particular, in the context of a conference, can be connected together and isolated from one another.

The merging of the circuit-oriented bearer TDM with the packet-oriented bearers RTP/RTCP is produced by an interposed media gateway MG for converting between different, network-specific data channel technologies RTP/RTCP (real time [control] protocol) and TDM (time division multiplex), while the merging of the signaling SS7 of the network PSTN with the signaling SIP of the networks IN is produced by interposed media gateway controllers MGC_{A/B} and MGC. The controller MGC_{A/B} produces direct interworking between the different network-specific signaling protocols ISUP of the network PSTN and SIP_{B} of the network IN_{B}. In contrast, a protocol BICC or SIP_T is used between the controllers MGC_{A/B} and MGC_{C} for indirect interworking between the different signaling protocols ISUP of the network PSTN and SIP_{C} of the network IN_{C}.

The gateway MG is controlled by its associated controller MGC_{A/B} by means of a protocol (preferably internationally standardized) such as MGCP (media gateway control protocol) or H.248. Said gateway is usually produced in the form of a separate unit which runs on a different physical device/hardware platform than the associated controller MGC_{A/B}.

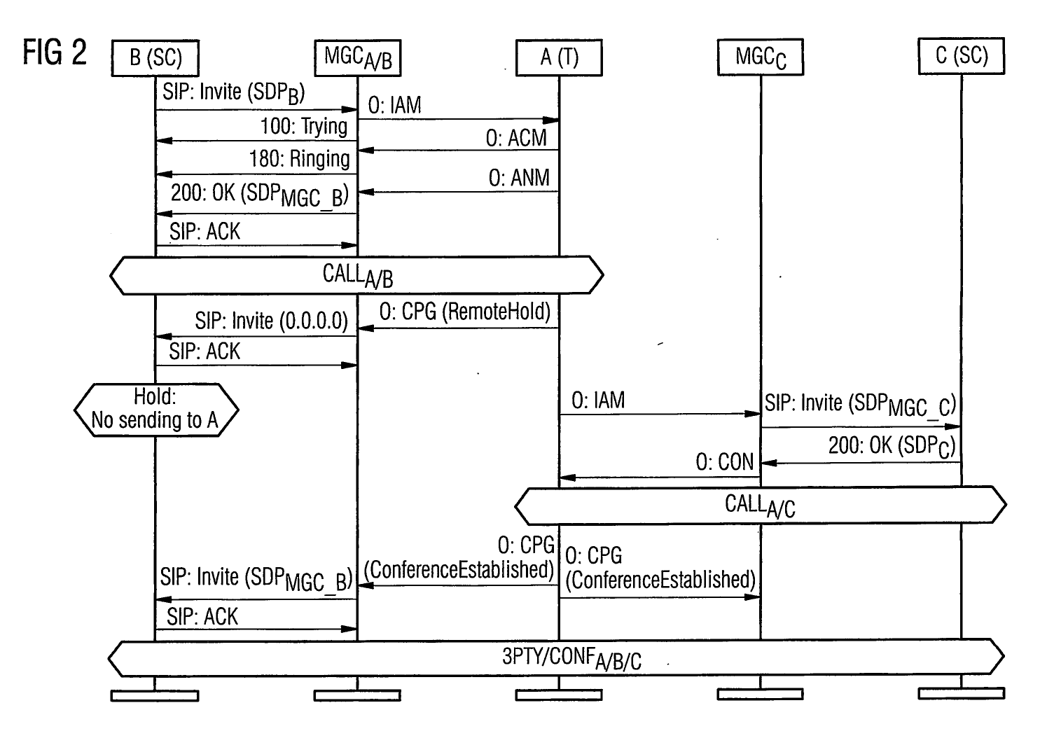

FIG. 2 shows the sequence of first ISUP messages for establishing the connection CALL_{A/B} between the subscribers A and B together with the sequence of second ISUP messages for extending the connection CALL_{A/B} to a conference with a further established connection CALL_{A/C} between the subscribers A and C. The figure further shows the interworking of the first ISUP messages in the protocol SIP_{B}, and the inventive interworking of the second messages in the protocols SIP_{B} and SIP_{C}.

It should be emphasized that the embodiments of the invention depicted in this way, despite their somewhat highly detailed illustration of concrete network scenarios, are to be considered merely as examples and not in any way restrictive in their application. It is clear to the specialist that the invention in all its conceivable network configurations functions in particular in other interworking scenarios. In particular the protocols SIP can be replaced by protocol from the H.323 family or other equivalent protocols.

An exemplary embodiment of the invention, in which the PSTN subscriber A establishes a performance feature in the form of a small conference 3PTY with the SIP subscribers B and C, is explained below. This example is also shown in FIG. 2.

First of all a connection CALL_{A/B} between the subscribers A and B is established in the usual way; in FIG. 2 the initiative is from the SIP subscriber B, but without restriction it could also be from the PSTN subscriber A. During interworking between the first protocol ISUP and the second protocol SIP, the SIP signaling SIP:Invite (SDPB) is then mapped onto the ISUP signaling O:IAM in the usual way. Similarly the ISUP signaling O:ACM and O:ANM, which shows the ringing of the telephone T and the acceptance of the call by the subscriber A, is mapped onto the SIP messages 180:Ringing and 200:OK (SDP_{MGC}_{_{—}}_{B}) in the usual way. After establishment the connection CALL_{A/B} includes at least one data channel TDM_{A/B}, RTP/RTCP_{A/B} (which in a telephone call is usually bidirectional) for transmitting information between the subscribers A and B. This channel is shown in FIG. 1.

In the next step it is intended that the existing call CALL_{A/B} shall be extended into a conference 3PTY with the subscriber C. The initiative for this is from the PSTN subscriber A. For this purpose the connection CALL_{A/B} is first put on HOLD by sending the ISUP message O:CPG (RemoteHold). As a result the data channel TDM_{A/B}, RTP/RTCP_{A/B} is then interrupted centrally in the switching center LEA in both transmission directions (see FIG. 1). Next the outgoing direction of the SIP client SC at subscriber B is deactivated by sending a SIP message SIP:Invite with the IP address of the controller MGC_{B}=0.0.0.0 (see FIG. 2). The interworking necessary for this purpose is defined in the draft standard Q.1912.SIP. Deactivation can alternatively be produced by sending a SIP message SIP:Invite with an attribute line “a=sendonly” or “a=inactive” (not shown in FIG. 2). Thus with regard to 3PTY and CONF nothing in the previous method for the performance feature CALL HOLD is changed.

Next a connection CALL_{A/C} from the subscriber A to the subscriber C is established in the usual way. This example shows an accelerated connection establishment procedure in which the ISUP messages O:ACM and O:ANM are replaced by a single ISUP message O:CON (=“connected”). This has no effect on the invention. After establishment the connection CALL_{A/C} includes at least one data channel TDM_{A/C}, RTP/RTCP_{A/C} for transmitting information between the subscribers A and C. This channel is shown in FIG. 1.

After establishment of the connection CALL_{A/C}, subscriber A initiates the merging of the two connections CALL_{A/B} and CALL_{A/C} into a small conference 3PTY. This merging is produced in the usual way by the switching center LEA of the network PSTN (see FIG. 1). In particular the two data channels TDM_{A/B}, RTP/RTCP_{A/B}, and TDM_{A/C}, RTP/RTCP_{A/C} are connected to one another so that all three subscribers can hear one another. This configuration of the connections CALL is notified to the said subscribers B and C by sending them two dedicated ISUP messages O:CPG (ConferenceEstablished), that is, this message is sent to both subscribers B, C.

Due to the deactivation of the subscriber B, however, this subscriber is still cut off from the conference 3PTY despite the merging of the data channels. This does not apply to the subscriber C, since said subscriber has not been deactivated. According to the invention there is therefore a different reaction to the two messages O:CPG (ConferenceEstablished), in that with regard to the subscriber B interworking is carried out and with regard to the subscriber C this does not occur. The interworking to subscriber B is designed so that the outgoing direction of the SIP client SC is reactivated by sending a SIP message SIP:Invite (SDP_{MGC}_{_{—}}_{B}) specifying the IP address of the controller MGCB (see FIG. 2). The activation can alternatively be produced by sending a SIP message SIP:Invite with an attribute line “a=sendrecv” or “a=recvonly” (not shown in FIG. 2), depending whether before deactivation the subscriber B has sent information bidirectionally or unidirectionally, or even by sending a SIP message SIP:Invite without the said attribute line. After execution of the interworking the subscriber B can also be heard in the conference 3PTY.

In a particularly advantageous variant, this interworking is omitted if the subscriber B has already been reactivated before the ISUP message O:CPG (ConferenceEstablished) is received. For this purpose the status of the subscriber B before the interworking is checked. In the “held” status a SIP message SIP: must be sent, but not otherwise.

This mapping also applies logically to the ISUP messages with the generic notification indicator parameters “Conference disconnected”, “Isolated” and “Reattached”. In the case of “conference disconnected” it is also necessary to check the status of the SIP subscriber: In the “held” status, the SIP message SIP:Invite is sent with the true IP address and/or the attribute line “a=sendrecv”. For the performance feature CONF, the value “Isolated” also has to be mapped into a SIP message Invite with IP address=0.0.0.0 and/or the attribute line “a=sendonly”, and the value “Reattached” has to be mapped into a SIP message SIP:Invite with the true IP address and/or the attribute line “a=sendrecv”.

To sum up, according to the invention the following minimum extension of the ITU-T draft standard Q.1912.SIP is proposed in order to support the features CONF (conference) and 3PTY (three parties):

| Call state | ISUP/BICC message | Mapping | SIP message |
|---|---|---|---|
| Answered | CPG with | ==> | INVITE with the attribute line “a=sendrecv”, or |
| | “Conference established” | | omitted attribute line, or “a=recvonly” for the |
| | | | offered media stream |
| | | | in case re-INVITE with “hold” (corresponding to |
| | | | “a=sendonly” or “a=inactive”) had already been |
| | | | sent and no re-INVITE with “no hold” |
| | | | (corresponding to “a=sendrecv”, or omitted |
| | | | attribute line) had been sent in the meanwhile. |
| | | | otherwise no mapping |
| Answered | CPG with | ==> | INVITE with the attribute line “a=sendrecv”, or |
| | “Conference disconnected” | | omitted attribute line, or “a=recvonly” for the |
| | | | offered media stream |
| | | | in case re-INVITE with “hold” (corresponding to |
| | | | “a=sendonly” or “a=inactive”) had already been |
| | | | sent and no re-INVITE with “no hold” |
| | | | (corresponding to “a=sendrecv”, or omitted |
| | | | attribute line) had been sent in the meanwhile. |
| | | | otherwise no mapping |
| Answered | CPG with “Isolated” | ==> | INVITE with the attribute line “a=sendonly” or |
| | | | “a=inactive” for the offered media stream |
| Answered | CPG with “Reattached” | ==> | INVITE with the attribute line “a=sendrecv”, or |
| | | | omitted attribute line, or “a=recvonly” for the |
| | | | offered media stream |
| before | CPG with | ==> | UPDATE with the attribute line “a=sendonly” or |
| answer | “Conference established” | | “a=inactive” for the offered media stream |
| | | | in case UPDATE with “hold” had already been |
| | | | sent and no UPDATE with “no hold” had been |
| | | | sent in the meanwhile. |
| | | | otherwise no mapping |
| before | CPG with | ==> | UPDATE with the attribute line “a=sendrecv”, or |
| answer | “Conference disconnected” | | omitted attribute line, or “a=recvonly” for the |
| | | | offered media stream |
| | | | in case UPDATE with “hold” had already been |
| | | | sent and no UPDATE with “no hold” had been |
| | | | sent in the meanwhile. |
| | | | otherwise no mapping |
| before | CPG with “Isolated” | ==> | UPDATE with the attribute line “a=sendonly” or |
| answer | | | “a=inactive” for the offered media stream |
| before | CPG with “Reattached” | ==> | UPDATE with the attribute line “a=sendrecv”, or |
| answer | | | omitted attribute line, or “a=recvonly” for the |
| | | | offered media stream |

Mapping:
□: Mapping from ISUP to SIP (SIP-T) only
CPG carries the generic notification with the contents listed above.

The total mapping of Q.734 messages is not necessary, since the Q.734.1 messages with the generic notification indicator parameters “Other party added”, “Other party isolated”, “Other party reattached”, “Other party split”, “Other party disconnected” and “Conference floating” (see Q.734.1[July 1996], Table 1-1) are merely for information and do not require the activation of the informed subscriber, and the mapping of the Q.734.2 message with the generic notification indicator parameter “remote hold” (see Q.734.2[07/96], Table 2-1) is already defined in the previous draft standard Q.1912.SIP.

It is clear to the specialist that the invention in all its relevant network configurations functions in particular in all TDM [symbol] IP interworking scenarios. It is also clear to the specialist that in the case of bidirectional data channels, that is, with transmitters at each end of the data channels, the invention can naturally be used without further changes in both transmission directions. The invention can also be used when there is no ISUP, BICC between the PSTN subscribers (ISDN, analog subscribers or mobile radio subscriber) and the SIP or SIP-T subscribers. The method mentioned above would then usually be carried out within switching centers. The interworking of NGN (next generation network) subscribers, such as VoDSL (voice over digital subscriber line), H323, etc. with SIP or SIP-T is thus also possible.

In conclusion it should be noted that the description of the communication network components that are relevant to the invention must not be seen as restrictive. It is particularly clear to a specialist that terms such as client, server, gateway, controller, etc. are to be thought of in the functional rather than the physical sense. In particular all function units can be produced, partially or wholly, as distributed components in software/computer program products P and/or via a plurality of physical devices.

1.-10. (canceled)

11. A method for interworking protocols to provide a performance feature in a communication network, comprising:
providing a first protocol that controls a first subscriber;
providing a second protocol that controls a second subscriber;
disconnecting an established data channel between the first subscriber and the second subscriber by deactivating a transmitter for the second subscriber;
receiving a notification of a call progress for the performance feature in accordance to the first protocol; and
interworking the notification into the second protocol.

12. The method according to claim 11,
wherein the performance feature is a large conference feature in accordance to the International Telecommunications Union (ITU) standard Q.734.1 or a small conference feature in accordance to the ITU standard Q.734.2, and
wherein the disconnect according to the first protocol is produced by interrupting the established data channel in a central transmission mode.

13. The method according to claim 12, wherein the deactivation occurs when a third subscriber is added to the conference or the subscriber is isolated from the conference.

14. The method according to claim 13, wherein interworking occurs when the transmitter is deactivated.

15. The method according to claim 14,
wherein the first protocol is ISUP and the second protocol is SIP,
wherein an attribute line is selected from the group consisting of: “a=sendonly”, “a=recvonly”, “a=sendrecv”, and “a=inactive”,
wherein an deactivate attribute line is “a=sendonly” or “a=inactive”,
wherein an activate attribute line is “a=sendrecv” or “recvonly”,
wherein an ISUP call progress (CPG) notification with a generic notification parameter “Conference established” is mapped into a SIP message with an activate attribute line or without an attribute line if a prior SIP message having a deactivate attribute line has been sent, wherein an ISUP CPG notification with a generic notification parameter “Conference disconnected” is mapped into a SIP message with an activate attribute line or without an attribute line if a prior SIP message having a deactivate attribute line has been sent,
wherein an ISUP CPG notification with a generic notification parameter “Isolated” is mapped into a SIP message with a deactivate attribute line, and
wherein an ISUP CPG notification with a generic notification parameter “Reattached” is mapped into a SIP message with an activate attribute line or without an attribute line.

16. The method according to claim 15,
wherein the SIP message is an “INVITE” when a call state is in an answered state, and
wherein the SIP message is an “UPDATE” if the call state is in a “before answer” state.

17. The method according to claim 16, wherein interworking occurs after a SIP message with a deactivate attribute line or no attribute line has been sent.

18. The method according to claim 15, wherein interworking occurs after a SIP message with a deactivate attribute line or no attribute line has been sent.

19. A media gateway controller for an interworking of protocols for a conference feature within a communication network, comprising
an ISUP protocol message for controlling a first subscriber;
a SIP protocol message for controlling a second subscriber;
a protocol converter from the ISUP protocol message to the SIP protocol message, and
a status of a transmitter for the second subscriber;
wherein the status is active or deactive, and
wherein when the ISUP protocol message is a call progress notification with “Conference established” or “Conference disconnected” and the status is disconnected, the SIP protocol message created by the converter indicates to activate the transmitter.

20. The controller according to claim 19,
wherein the SIP message is an INVITE and includes an activate attribute of “a=sendrecv” or “recvonly” or
wherein the SIP message is an UPDATE and includes an activate attribute of “a=sendrecv” or “recvonly”.

21. The controller according to claim 19, wherein when the ISUP protocol message is a call progress notification with “Isolated” the SIP protocol message created by the converter includes a deactivate attribute of “a=sendonly” or “a=inactive”.

22. The controller according to claim 21, wherein the status is deactive after a prior ISUP message is converted to a prior SIP message having an deactivate attribute of “a=inactive” or “a=sendonly” or the prior SIP message does not have “a=recvonly” or “a=sendrecv”.

23. The controller according to claim 22, wherein the status is deactive after a prior ISUP message is converted to a prior SIP message having an deactivate attribute of “a=inactive” or “a=sendonly” or the prior SIP message does include and activate attribute.

24. The controller according to claim 23, wherein when the ISUP protocol message is a call progress notification with “Reattached” the SIP protocol message created by the converter includes a activate attribute.

25. A computer readable medium operable to execute the following on a processor for interworking protocols to provide a conference feature in a communication network, comprising:
deactivating a transmitter for an established data channel between a first subscriber and a second subscriber when adding a third subscriber to the conference or isolating the third subscriber from the conference,
wherein a first protocol controls the first subscriber, and
wherein a second protocol controls the second subscriber;
receiving a notification of a call progress for the conference feature in accordance to the first protocol; and
mapping the notification into a message in accordance to the second protocol; and
sending the second message to the first subscriber.

26. The method according to claim 25,
wherein the first protocol is ISUP and the second protocol is SIP,
wherein an attribute line is selected from the group consisting of: “a sendonly”, “a=recvonly”, “a=sendrecv”, and “a=inactive”,
wherein an deactivate attribute line is “a=sendonly” or “a=inactive”,
wherein an activate attribute line is “a=sendrecv” or “recvonly”,
wherein an ISUP call progress (CPG) notification with a generic notification parameter “Conference established” is mapped into a SIP message with an activate attribute line or without an attribute line if a prior SIP message having a deactivate attribute line has been sent,
wherein an ISUP CPG notification with a generic notification parameter “Conference disconnected” is mapped into a SIP message with an activate attribute line or without an attribute line if a prior SIP message having a deactivate attribute line has been sent,
wherein an ISUP CPG notification with a generic notification parameter “Isolated” is mapped into a SIP message with a deactivate attribute line, and
wherein an ISUP CPG notification with a generic notification parameter “Reattached” is mapped into a SIP message with an activate attribute line or without an attribute line.

27. The method according to claim 26,
wherein the SIP message is an “INVITE” when a call state is in an answered state, and
wherein the SIP message is an “UPDATE” if the call state is in a “before answer” state.
